(19) United States
(12) Patent Application Publication
(10) Pub. No.: US 2022/0405982 A1
(43) Pub. Date: Dec. 22, 2022

(54) SPECTRUM ALGORITHM WITH TRAIL RENDERER

(71) Applicant: Lemon Inc., Grand Cayman (KY)

(72) Inventors: Kexin Lin, Los Angeles, CA (US); Yunzhu Li, Los Angeles, CA (US)

(21) Appl. No.: 17/353,425

(22) Filed: Jun. 21, 2021

(51) Int. Cl. G06T 11/00; G06T 7/70; G10L 25/18; G10L 21/14

(52) U.S. Cl. CPC G06T 11/00; G06T 7/70; G10L 25/18; G10L 21/14; G06T 2207/10016

(57) ABSTRACT

Systems and methods for rendering motion-audio visualizations to a display are described. More specifically, video data and audio data is obtained. A position of a target object in each of one or more video frames of the video data is determined. Additionally, a video data comprising one or more video frames is determined. Audio visualizations for the predetermined time period are determined based on the frequency spectrum. A rendered video is generated by applying the audio visualizations at the position of the target object in the one or more video frames for the predetermined time period.

### BACKGROUND

Audio or music visualization is a feature often found in electronic music visualizers and media players. Audio visualization may be applied to music to generate animated graphics based on the music. The graphics may be generated and rendered in real-time and synchronized with the music as it is being played. For example, different effects of the graphics may be visualized based on changes in loudness and/or frequency spectrum of the music. However, many of these audio visualization techniques do not consider video data that may be combined with audio data. Hence, there remains a need to develop visualization techniques for rendering audio visualizations based on audio and video data to enhance the user experience.

It is with respect to these and other general considerations that the aspects disclosed herein have been described. Also, although relatively specific problems may be discussed, it should be understood that the examples should not be limited to solving the specific problems identified in the background or elsewhere in this disclosure.

### SUMMARY

In accordance with at least one example of the present disclosure, a method for rendering motion-audio visualizations to a display is provided. The method may include obtaining video data comprising one or more video frames, determining a position of a target object in each of the one or more video frames, obtaining audio data, determining a frequency spectrum from the audio data for a predetermined time period, determining audio visualizations for the predetermined time period based on the frequency spectrum, and generating a rendered video by applying the audio visualizations at the position of the target object in the one or more video frames for the predetermined time period.

In accordance with at least one example of the present disclosure, a computing device for rendering motion-audio visualizations to a display is provided. The computing device comprises a processor and a memory having a plurality of instructions stored thereon that, when executed by the processor, causes the computing device to obtain video data comprising one or more video frames, determine a position of a target object in each of the one or more video frames, obtain audio data, determine a frequency spectrum from the audio data for a predetermined time period, determine audio visualizations for the predetermined time period based on the frequency spectrum, and generate a rendered video by applying the audio visualizations at the position of the target object in the one or more video frames for the predetermined time period.

In accordance with at least one example of the present disclosure, a non-transitory computer-readable medium storing instructions for rendering motion-audio visualizations to a display is provided. The instructions when executed by one or more processors of a computing device, cause the computing device to obtain video data comprising one or more video frames, determine a position of a target object in each of the one or more video frames, obtain audio data, determine a frequency spectrum from the audio data for a predetermined time period, determine audio visualizations for the predetermined time period based on the frequency spectrum, and generate a rendered video by applying the audio visualizations at the position of the target object in the one or more video frames for the predetermined time period

Any of the one or more above aspects in combination with any other of the one or more aspects. Any of the one or more aspects as described herein.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 depicts an example motion-audio visualization system in accordance with examples of the present disclosure;

FIG. 2 depicts details of a computing device of a motion-audio visualization system in accordance with examples of the present disclosure;

FIGS. 3A-3C depict example frames of a video rendered with motion-audio visualization;

FIG. 4 depicts details of a method for rendering motion-audio visualization in accordance with examples of the present disclosure;

FIGS. 5-7 depict details of a method for rendering motion-audio visualization in accordance with examples of the present disclosure;

FIG. 8 depicts a block diagram illustrating physical components (e.g., hardware) of a computing device with which aspects of the disclosure may be practiced;

FIG. 9A illustrates a first example of a computing device with which aspects of the disclosure may be practiced;

FIG. 9B illustrates a second example of a computing device with which aspects of the disclosure may be practiced; and

FIG. 10 illustrates at least one aspect of an architecture of a system for processing data in accordance with examples of the present disclosure.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In accordance with examples of the present disclosure, motion-audio visualization may be performed to combine audio visualization of audio music with motion tracking of a target object (e.g., a particular body part) in a video clip based on a visualization template. The motion-audio visualization may include trail particles that are applied to a path or positions of the target object in the video clip based on one or more characteristics of the audio music. In some aspects, the visualization template may configure the trail particles that follow a frequency spectrum, loudness, and/or rhythm of the audio music. Additionally, the visualization template may further configure a behavior of the particles that are configured to be emitted from the target object that appears and/or is tracked in the video data. Accordingly, the parameters of the visualization template may be continually or periodically updated based on the audio music and the video clip. In other words, the motion-audio visualization allows a computing device to create audio-reactive visuals or graphics that follow the target object in real-time as the music is being played.

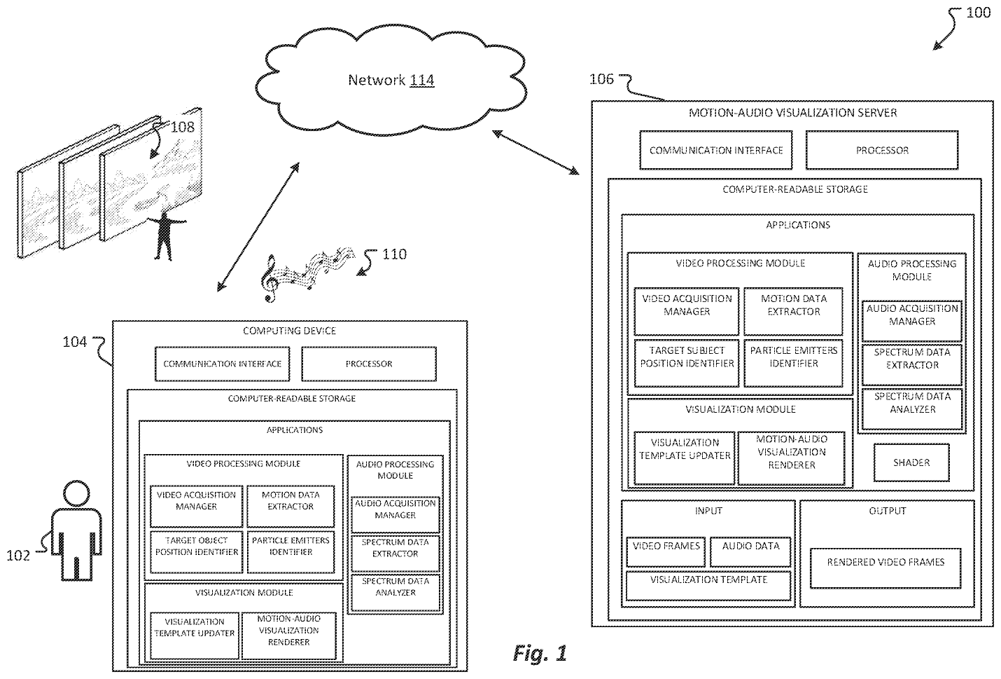

FIG. 1 depicts a motion-audio visualization system 100 for rendering motion-audio visualization in accordance with examples of the present disclosure. For example, a user 102 may generate, receive, acquire, or otherwise obtain a video clip 108. Subsequently, the user may select audio music 110 to be added to the video clip 108. The motion-audio visualization system 100 allows the user 102 to create audio-reactive visuals or graphics that follow a target subject in the video clip based on the selected music 110. To do so, the motion-audio visualization system 100 includes a computing device 104 associated with the user 102 and a motion-audio visualization server 106 that is communicatively coupled to the computing device 104 via a network 114. The network 114 may include any kind of computing network including, without limitation, a wired or wireless local area network (LAN), a wired or wireless wide area network (WAN), and/or the Internet.

In examples, the user 102 may utilize the computing device 104 to acquire the video clip 108 and the music 110. The user 102 may generate the video clip 108 using a camera communicatively coupled to a computing device 104. Alternatively, or additionally, the user 102 may receive, acquire, or otherwise obtain the video clip 108 on the computing device 104. In some examples, the user 102 may edit the video clip 108 to add the music 110. In some aspects, the user 102 may utilize the computing device 104 to transmit the video clip 108 and the music 110 to the motion-audio visualization server 106 via the network 114. The computing device 104, although depicted as a desktop computer in FIG. 1 for example, may be any one of a portable or non-portable computing device. For example, the computing device 104 may be a smartphone, a laptop, a desktop, a server, a wearable electronic device, an intelligent home appliance, etc. The video clip 108 may be acquired in any format and may be in compressed and/or decompressed form.

The computing device 104 is configured to track a target object in the video clip 108 and apply visualizations of the audio music 110 to the target object. In other words, graphics that follow a frequency spectrum of the audio music 110 may be applied to a path or positions of the target object in the video clip 108. To do so, the computing device 104 may obtain video data including one or more video frames 108 and process each video frame to extract motion data of the target object. The computing device 104 is configured to identify the target object in each video frame to track motion of a target object throughout the video clip 108 using a motion tracking algorithm. For example, the target object may be a particular body part (e.g., hands, arms, head, legs, and feet) of one or more individuals appearing in the video clip 108. In the illustrative aspect, the target object is configured by a visualization template. In some aspects, the user 102 may select the target object to be tracked throughout the video clip 108.

Additionally, the computing device 104 may determine positions of particle emitters based on the position of the target object in each frame of the video data. The particle emitters control a source of particles with a set of video visualization parameters. The video visualization parameters control a behavior of particles that are configured to be emitted from the target object. For example, the video visualization parameters may include, but not limited to, a particle color, a spawning rate (e.g., a number of particles generated per unit of time), an initial velocity vector (e.g., a direction that the particles are emitted upon creation), and/or a particle lifetime (e.g., a length of time that each individual particle exists before disappearing).

Furthermore, the computing device 104 may obtain audio music 110 selected by the user 102 to be added to the video clip 108. In the illustrative aspect, frequency spectrum data may be extracted from the audio music 110 for every predetermined time period (e.g., 3 seconds). The frequency spectrum data may be used to update one or more audio visualization parameters of the visualization template applied to the video frames for the duration of the predetermined time period. For example, the audio visualization parameters may define, but are not limited to, a width, height, color, and/or brightness of one or more graphics or effects to be added to the corresponding video frames. Accordingly, the computing device 104 may apply the visualization template to each video frame for the duration of the predetermined time period to render motion-audio visualization.

Alternatively, or additionally, the motion-audio visualization may be performed by a computing device 104 associated with the user 102. In such aspects, the visualization template may be applied to the video clip 108 by the computing device 104 to be presented to the user 102. Alternatively, the visualization template may be applied to the video clip 108 once the video clip 108 is uploaded to the server 106 to render the motion-audio visualization.

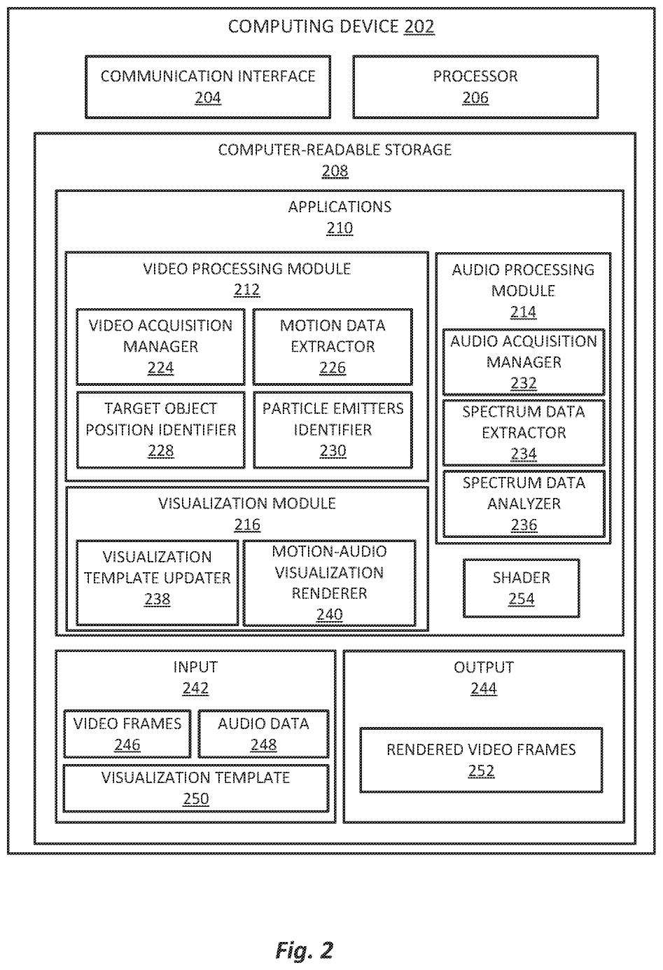

Referring now to FIG. 2, the computing device 202 in accordance with examples of the present disclosure is described. The computing device 202 may be the same as or similar to the computing device 104 previously described in FIG. 1. The computing device 202 may include a communication interface 204, a processor 206, and a computer-readable storage 208. In examples, the communication interface 204 may be coupled to a network and receive the video clip 108 and the audio music 110. The video clip 108 may be stored as video frames 246 and the music 110 may be stored as audio data 248.

In some examples, one or more visualization templates may also be received at the communication interface 204 and stored as the visualization templates 250. In some aspects, the computing device 202 may retrieve the visualization template that has been previously received and stored in the visualization template database that is communicatively coupled to the computing device 202. To do so, for example, each visualization template may be assigned an identification number that may be used to retrieve the visualization template that is already stored in the computing device 202.

The visualization templates 250 may configure one or more video visualization parameters and one or more audio visualization parameters. The video visualization parameters are associated with the video data and control a behavior of particles that are configured to be emitted from a target object that appears and/or is tracked in the video data. For example, the video visualization parameters may include, but are not limited to, a particle color, a spawning rate (e.g., a number of particles generated per unit of time), an initial velocity vector (e.g., a direction that the particles are emitted upon creation), and/or a particle lifetime (e.g., a length of time that each individual particle exists before disappearing). Additionally, the video visualization parameters may include a target object of the video data to be tracked throughout the video clip.

Furthermore, the audio visualization parameters are associated with the audio data and control the audio visualization to be added to the video data. For example, the audio visualization parameters may include, but are not limited to, one or more graphics or effects to be added to the video data and a width, height, color, and/or brightness of the one or more graphics or effects. In the illustrative aspect, the visualization template may include default values for the video visualization parameters and audio visualization parameters, which may be updated or adjusted based on the video data and audio data, respectively.

In examples, one or more applications 210 may be provided by the computing device 104. The one or more applications 210 may include a video processing module 212, an audio processing module 214, and a visualization module 216. The video processing module 212 may include a video acquisition manager 224, a motion data extractor 226, a target object position identifier 228, and a particle emitters identifier 230. The video acquisition manager 224 is configured to receive, acquire, or otherwise obtain video data that includes one or more video frames. The motion data extractor 226 is configured to extract motion data from the video data. The video data may be acquired in any format and may be in compressed and/or decompressed form. The target object position identifier 228 is configured to identify the target object in each video frame to track motion or position of a target object throughout the video frames using a motion tracking algorithm. For example, the target object may be a particular body part (e.g., hands, arms, head, legs, and feet) of one or more individuals appear in the video clip 108. In the illustrative aspect, the target object is configured by a visualization template. The particle emitters identifier 230 is configured to determine positions of particle emitters based on the position of the target object in each frame of the video data. The particle emitters control a source of particles with a set of video visualization parameters. The video visualization parameters control a behavior of particles that are configured to be emitted from a target object. For example, the video visualization parameters may include, but are not limited to, a particle color, a spawning rate (e.g., a number of particles generated per unit of time), an initial velocity vector (e.g., a direction that the particles are emitted upon creation), and/or a particle lifetime (e.g., a length of time that each individual particle exists before disappearing).

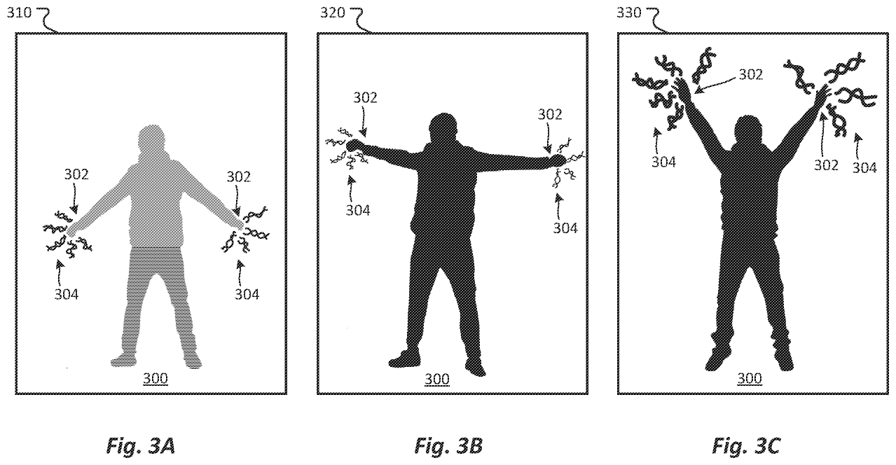

Additionally, the audio processing module 214 may include an audio acquisition manager 232, a spectrum data extractor 234, and a spectrum data analyzer 236. The audio acquisition manager 232 is configured to receive, acquire, or otherwise obtain audio data. The spectrum data extractor 234 is configured to extract spectrum data from the audio data every predetermined time period. The frequency spectrum data may be used to update one or more audio visualization parameters of the visualization template. The spectrum data analyzer 236 is configured to analyze the spectrum data to divide the spectrum data into one or more groups based on a frequency range (e.g., high range, medium range, and low range) and determine an average frequency for each frequency range group. The average frequency numbers are used to update one or more audio visualization parameters for the duration of the predetermined time period. For example, the audio visualization parameters define, but are not limited to, a width, height, color, and/or brightness of one or more graphics or effects to be added to the video data for the duration of the predetermined time period. For instance, the audio data with more high frequency notes may have higher average frequency numbers in all frequency range groups. In such an example, bolder and greater width, height, and brightness of the graphics may be added to one or more video frames of the video data (e.g., FIG. 3C) for the duration of the predetermined time period.

Furthermore, the visualization module 216 may further include a visualization template updater 238 and a motion-audio visualization renderer 240. The visualization template updater 238 is configured to update the video visualization parameters and the audio visualization parameters of the visualization template 250. The motion-audio visualization renderer 240 is configured to apply the visualization template 250 to each frame of the video data to render motion-audio visualization. In examples, the motion-audio visualization renderer 240 includes or otherwise is in communication with the shader 254. The shader 254 is configured to receive the visualization template; based on the visualization template, the shader 254 is configured to generate or otherwise cause the audio visualizations to be rendered. For example, the shader 254 may change a visual effect associated with one or more particles which may include, but is not limited to, producing blur, light bloom, (e.g., glow), lighting (e.g., shadows, highlights, and translucency), bump mapping, and distortion.

FIGS. 3A-3C illustrate exemplary video frames 310, 320, 330 of a video clip with motion-audio visualization in accordance with examples of the present disclosure. In the illustrative example, a target object 302 is the hands of an individual 300 and one or more graphics or effects 304 are depicted as two sine waves.

In examples, upon receiving audio data to be added to the video clip, a frequency spectrum of the audio data may be determined for every predetermined time period. The resulting frequency spectrum data may be divided into three frequency groups based on a frequency range (e.g., high range, medium range, and low range), and an average frequency is determined for each frequency group. The three average frequency numbers are used to change one or more audio visualization parameters associated with one or more graphics or effects to be added to the video frames for the predetermined time period (e.g., 3 seconds).

For example, the average frequency number for the high range group may be associated with a width of the graphics or effects, the average frequency number for the medium range group may be associated with a height of the graphics or effects, and the average frequency number for the low range group may be associated with a brightness of the graphics or effects. In such an example, as the average frequency number for the high range group decreases from the video frame 310 to the video frame 320, the width of the graphics 304 also decreases, thus, creating thinner sine waves, as illustrated in FIG. 3B. In contrast, as the average frequency number for the high range group increases from the video frame 310 to the video frame 330, the width of the graphics 304 also increases, thus, creating thicker sine waves, as illustrated in FIG. 3C.

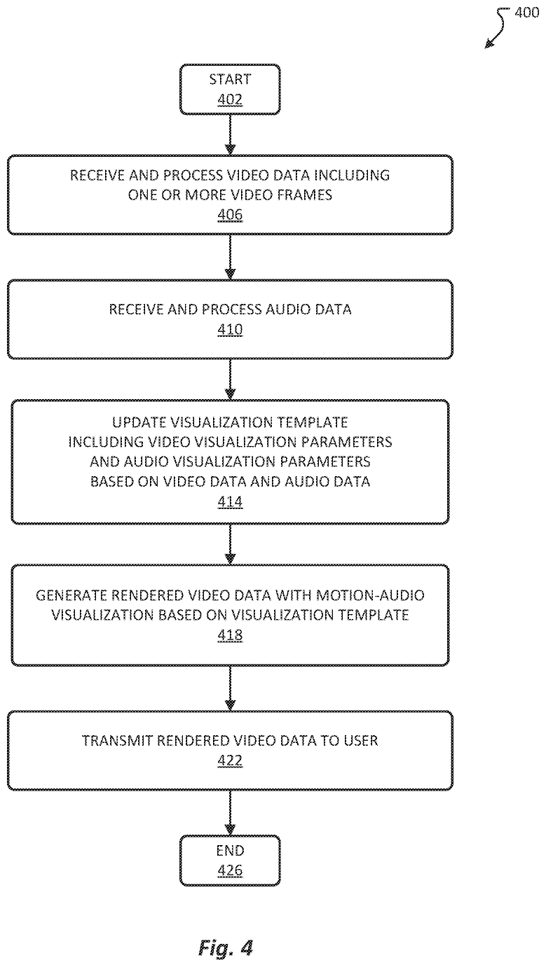

Referring now to FIG. 4, a simplified method for rendering motion-audio visualization in accordance with examples of the present disclosure is provided. A general order for the steps of a method 400 is shown in FIG. 4. Generally, the method 400 starts at 402 and ends at 426. The method 400 may include more or fewer steps or may arrange the order of the steps differently than those shown in FIG. 4. The method 400 can be executed as a set of computer-executable instructions executed by a computer system and encoded or stored on a computer readable medium. In the illustrative aspect, the method 400 is executed by a computing device associated with a user (e.g., 104). However, it should be appreciated that aspects of the method 400 may be performed by one or more processing devices, such as a computing device or server (e.g., 104, 106). Further, the method 400 can be performed by gates or circuits associated with a processor, Application Specific Integrated Circuit (ASIC), a field programmable gate array (FPGA), a system on chip (SOC), a neural processing unit, or other hardware device. Hereinafter, the method 400 shall be explained with reference to the systems, components, modules, software, data structures, user interfaces, etc. described in conjunction with FIGS. 1-3.

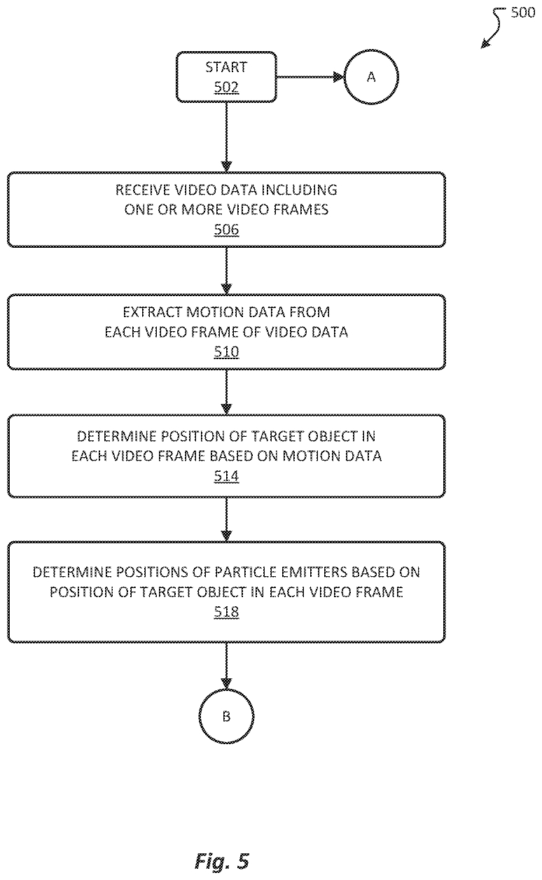

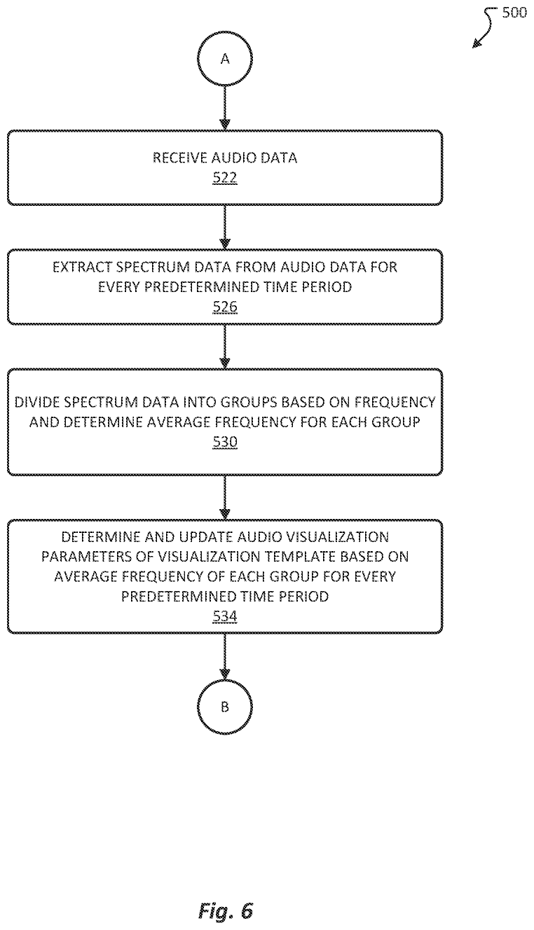

The method 400 starts at 402, where flow may proceed to 406. At 406, the computing device receives video data (e.g., video clip 108) that includes one or more video frames. The received video data is further processed by the computing device, which is further described in method 500 shown in FIG. 5. At 410, the computing device receives audio data (e.g., audio music 110) selected by the user 102 to be added to the video data. The received audio data is further processed at a computing device, which is further described in method 500 shown in FIG. 6. It should be appreciated that the computing device may perform the operations 406 and 410 simultaneously. Alternatively, the operation 410 may be performed subsequent to the operation 406. In some aspects, the operation 406 may be performed subsequent to the operation 410.

Once operations 406 and 410 have been performed, at 414, the computing device updates or modifies a visualization template by changing one or more video visualization parameters and one or more audio visualization parameters based on the video and audio data. The video visualization parameters are associated with the video data and control a behavior of particles that are configured to be emitted from a target object appears in the video data. For example, the video visualization parameters may include, but are not limited to, a particle color, a spawning rate (e.g., a number of particles generated per unit of time), an initial velocity vector (e.g., a direction that the particles are emitted upon creation), and/or a particle lifetime (e.g., a length of time that each individual particle exists before disappearing). Additionally, the video visualization parameters may include a target object of the video data to be tracked throughout the video clip. The audio visualization parameters are associated with the audio data and control audio visualization to be added to the video data. For example, the audio visualization parameters include, but are not limited to, one or more graphics or effects to be added to the video data and a width, height, color, and/or brightness of the one or more graphics.

In the illustrative aspect, the visualization template includes default values for the video visualization parameters and audio visualization parameters and are updated or adjusted based on the video data and audio data, which is described in detail below in method 500. However, it should be appreciated that, in some aspects, one or more values for the video visualization parameters and audio visualization parameters of the visualization template may be selected or configured by the user 102.

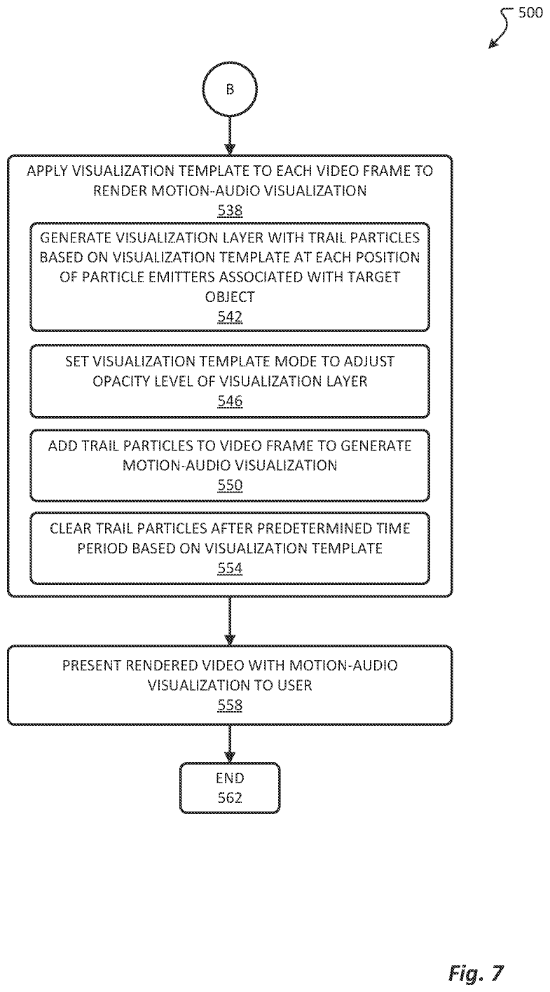

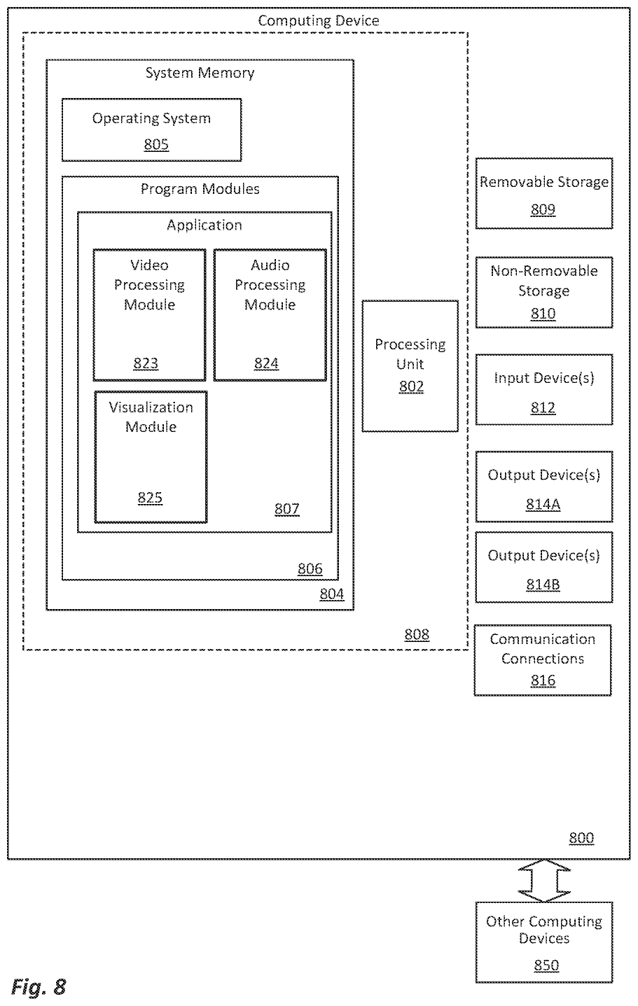

At 418, the computing device generates a rendered video with motion-audio visualization based on the visualization template, which is described in detail in operations 538-554 of method 500 shown in FIG. 7. Subsequently, at 422, the rendered video is transmitted to the user 102 for display. The method may end at 426.

It should be appreciated that the motion-audio visualization may be applied as the video data is being collected in real-time by the user 102. Alternatively, the motion-audio visualization may be applied to the video data once the user 102 uploads the complete video clip. It should be appreciated that the motion-audio visualization may be performed by the motion-audio visualization server 106, detailed of which are similar as descripted above. It should be also appreciated that parts of the motion-audio visualization may be performed by the computing device 104 and part of the motion-audio visualization may be performed by the motion-audio visualization server 106, detailed of which are similar as descripted above.

Referring now to FIGS. 5-8, a detailed method for rendering motion-audio visualization in accordance with examples of the present disclosure is provided. A general order for the steps of a method 500 is shown in FIGS. 5-8. Generally, the method 500 starts at 502 and ends at 562. The method 500 may include more or fewer steps or may arrange the order of the steps differently than those shown in FIGS. 5-7. The method 500 can be executed as a set of computer-executable instructions executed by a computer system and encoded or stored on a computer readable medium. In the illustrative aspect, the method 500 is executed by a computing device (e.g., 104, 202). However, it should be appreciated that aspects of the method 500 may be performed by one or more processing devices, such as a computing device or server (e.g., 104, 106). Further, the method 500 can be performed by gates or circuits associated with a processor, Application Specific Integrated Circuit (ASIC), a field programmable gate array (FPGA), a system on chip (SOC), a neural processing unit, or other hardware device. Hereinafter, the method 500 shall be explained with reference to the systems, components, modules, software, data structures, user interfaces, etc. described in conjunction with FIGS. 1-3.

The method 500 starts at 502, where flow may proceed to 506. At 506, the computing device receives video data (e.g., video clip 108) including one or more video frames. At 510, the computing device processes each frame of the video data to extract motion data for each frame. For example, the motion data may be extracted using a motion tracking algorithm to track positions of one or more objects appear in the video data.

At 514, the computing device determines a position of a target object in each frame of the video data based on the motion data. As described above, the computing device is configured to identify a position of the target object in each frame of the video data to track the motion of the target object throughout the video clip. For example, the target object may be a particular body part (e.g., hands, arms, head, legs, and feet) of one or more individuals appearing in the video clip 108. As discussed above, the target object in the example shown in FIG. 3 is the hands. In the illustrative aspect, the target object is configured by a visualization template. In some aspects, the user 102 may select the target object to be tracked throughout the video clip.

At 518, the computing device determines positions of particle emitters based on the position of the target object in each frame of the video data. The particle emitters control a source of particles with a set of video visualization parameters. The video visualization parameters control a behavior of particles that are configured to be emitted from the target object. For example, the video visualization parameters may include, but are not limited to, a particle color, a spawning rate (e.g., a number of particles generated per unit of time), an initial velocity vector (e.g., a direction that the particles are emitted upon creation), and/or a particle lifetime (e.g., a length of time that each individual particle exists before disappearing). Subsequently, the method 500 proceed to operation 538 in FIG. 7 as shown by the alphanumeric character B in FIGS. 5 and 7, which is described further below.

Referring back to the start 502, the method 500 may proceed to 522 in FIG. 6 as shown by the alphanumeric character A in FIGS. 5 and 6. It should be appreciated that the computing device may perform the operations 506 and 522 simultaneously. Alternatively, the operation 522 may be performed subsequent to the operation 506. In some aspects, the operation 506 may be performed subsequent to the operation 522.

At 522, the computing device receives audio data (e.g., audio music 110) selected by the user 102 to be added to the video data. Subsequently, at 526, the computing device extracts frequency spectrum data from the audio data for every predetermined time period (e.g., 3 seconds). Once the frequency spectrum data is extracted, the method 500 proceeds to operation 530 to divide the spectrum data into one or more groups based on a frequency range (e.g., high range, medium range, and low range). The computing device determines an average frequency for each group. The average frequency numbers are used to update one or more audio visualization parameters for the duration of the predetermined time period. For example, an average frequency number for one group may be associated with at least one particular audio visualization parameter. The audio visualization parameters may include, but not limited to, a width, height, color, and/or brightness of one or more graphics or effects to be added to video frames for the duration of the predetermined time period.

Accordingly, at 534, the computing device determines and changes one or more audio visualization parameters of the visualization template based on the average frequency number for each group. For example, if a first frequency range group is associated with a width of the graphics or effects, a higher average frequency of the first range group correlates to a bolder, greater width of the graphics or effects (e.g., FIG. 3C) added to the video frames during the predetermined time period. Similarly, a lower average frequency of the first range group correlates to a weaker, thinner width of the graphics or effects (e.g., FIG. 3B) during the predetermined time period. Once the visualization template is updated based on the frequency spectrum of the audio data, the method 500 proceeds to operation 538 in FIG. 7 as shown by the alphanumeric character B in FIGS. 6 and 7.

At 538, the computing device applies the visualization template to each frame of the video data to render motion-audio visualization. To do so, at 542, the computing device generates a visualization layer with trail particles based on the visualization template. Specifically, in the illustrative aspect, the trail particles include graphics that follow a frequency spectrum of the audio data which is applied to the positions of particle emitters in the corresponding frame of the video data (e.g. indicating a path or position of the target object in the video data). As described above, the video visualization parameters control a behavior of trail particles that are configured to be emitted from the target object, and the audio visualization parameters define a width, height, color, and/or brightness of one or more graphics or effects that are configured to be applied to the trail particles.

Subsequently, or simultaneously, at 546, the computing device further sets a mode of the visualization template to blend the trail particles into the corresponding frame of the video data. For example, an opacity level of the visualization layer of the trail particles may be set to zero (e.g., a transparent background layer). In such an example, when the visualization layer is added to a corresponding video frame at 550, the audio visualization (e.g., the trail particles) seamlessly blends into the video frame without hindering background noise. Subsequently, at 554, the trail particles added to the video frame disappear after a predetermined time period (i.e., particle lifetime) configured by the visualization template. The computing device repeats the motion-audio visualization process for each frame of the video data received at operation 506. Once the motion-audio visualization process is completed, at 558, the computing device presents the rendered video with the motion-audio visualization to the user 102. The method may end at 562.

It should be appreciated that, although the method 500 is described to be performed by the computing device 104, 202, one or more operations of the method 500 may be performed by any computing device, such as the motion-audio visualization server 106.

FIG. 8 is a block diagram illustrating physical components (e.g., hardware) of a computing device 800 with which aspects of the disclosure may be practiced that can perform the operation of motion-audio visualization as described above. The computing device components described below may be suitable for the computing devices described above. For example, the computing device 800 may represent the computing device 104 of FIG. 1 and the computing device 202 of FIG. 2. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories.

The system memory 804 may include an operating system 805 and one or more program modules 806 suitable for performing the various aspects disclosed herein such. The operating system 805, for example, may be suitable for controlling the operation of the computing device 800. Furthermore, aspects of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, several program modules and data files may be stored in the system memory 804. While executing on the at least one processing unit 802, the program modules 806 may perform processes including, but not limited to, one or more aspects, as described herein. The application 820 includes a video processing module 823, an audio processing module 824, and a visualization module 825, as described in more detail in FIG. 2. Other program modules that may be used in accordance with aspects of the present disclosure may include electronic mail and contacts applications, word processing applications, spreadsheet applications, database applications, slide presentation applications, drawing or computer-aided application programs, etc., and/or one or more components supported by the systems described herein.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The computing device 800 may also have one or more input device(s) 812 such as a keyboard, a mouse, a pen, a sound or voice input device, a touch or swipe input device, etc. The output device(s) 814A such as a display, speakers, a printer, etc. may also be included. An output 814B, corresponding to a virtual display may also be included. The aforementioned devices are examples and others may be used. The computing device 800 may include one or more communication connections 816 allowing communications with other computing devices 450. Examples of suitable communication connections 816 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

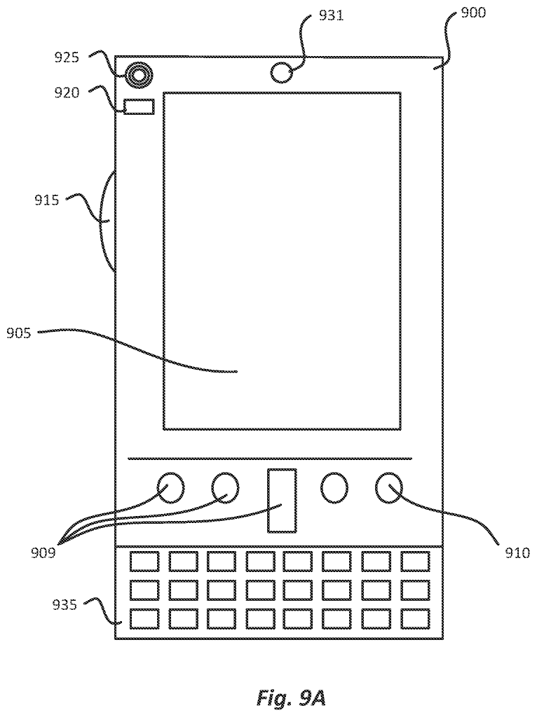

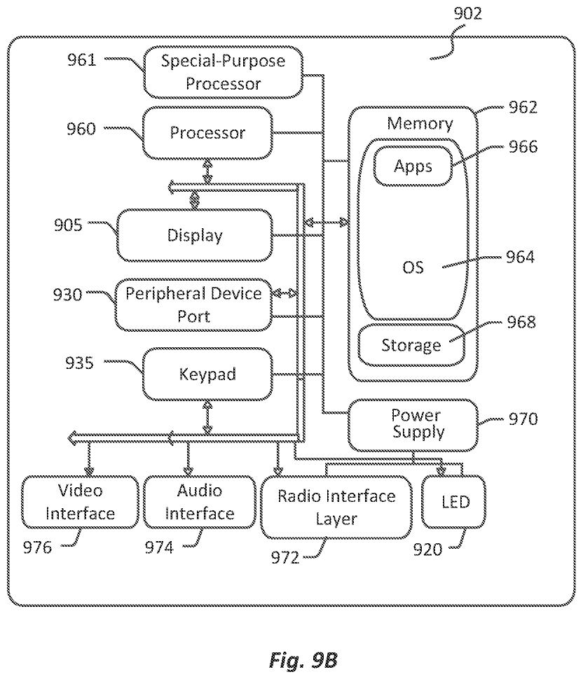

FIGS. 9A and 9B illustrate a computing device or mobile computing device 900 suitable for performing the various aspects disclosed herein, for example, a mobile telephone, a smart phone, wearable computer (such as a smart watch), a tablet computer, a laptop computer, a smart home appliance, and the like, with which aspects of the disclosure may be practiced that can perform the operation of motion-audio visualization as described above. With reference to FIG. 9A, one aspect of a mobile computing device 900 for implementing the aspects is illustrated. In a basic configuration, the mobile computing device 900 is a handheld computer having both input elements and output elements. The mobile computing device 900 typically includes a display 905 and one or more input buttons 909/910 that allow the user to enter information into the mobile computing device 900. The display 905 of the mobile computing device 900 may also function as an input device (e.g., a touch screen display). If included, an optional side input element 915 allows further user input. The side input element 915 may be a rotary switch, a button, or any other type of manual input element. In alternative aspects, mobile computing device 900 may incorporate more or less input elements. For example, the display 905 may not be a touch screen in some aspects. In yet another alternative aspect, the mobile computing device 900 is a portable phone system, such as a cellular phone. The mobile computing device 900 may also include an optional keypad 935. Optional keypad 935 may be a physical keypad or a “soft” keypad generated on the touch screen display. In various aspects, the output elements include the display 905 for showing a graphical user interface (GUI), a visual indicator 931 (e.g., a light emitting diode), and/or an audio transducer 925 (e.g., a speaker). In some aspects, the mobile computing device 900 incorporates a vibration transducer for providing the user with tactile feedback. In yet another aspect, the mobile computing device 900 incorporates input and/or output ports 930, such as an audio input (e.g., a microphone jack), an audio output (e.g., a headphone jack), and a video output (e.g., a HDMI port) for sending signals to or receiving signals from an external source.

FIG. 9B is a block diagram illustrating the architecture of one aspect of computing device, a server, or a mobile computing device. That is, the mobile computing device 900 can incorporate a system (902) (e.g., an architecture) to implement some aspects. The system 902 can implemented as a “smart phone” capable of running one or more applications (e.g., browser, e-mail, calendaring, contact managers, messaging clients, games, and media clients/players). In some aspects, the system 902 is integrated as a computing device, such as an integrated personal digital assistant (PDA) and wireless phone.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and/or one or more components supported by the systems described herein. The system 902 also includes a non-volatile storage area 968 within the memory 962. The non-volatile storage area 968 may be used to store persistent information that should not be lost if the system 902 is powered down. The application programs 966 may use and store information in the non-volatile storage area 968, such as e-mail or other messages used by an e-mail application, and the like. A synchronization application (not shown) also resides on the system 902 and is programmed to interact with a corresponding synchronization application resident on a host computer to keep the information stored in the non-volatile storage area 968 synchronized with corresponding information stored at the host computer. As should be appreciated, other applications may be loaded into the memory 962 and run on the mobile computing device 900 described herein (e.g. a video processing module 823, an audio processing module 824, a visualization module 825, etc.).

The system 902 has a power supply 970, which may be implemented as one or more batteries. The power supply 970 might further include an external power source, such as an AC adapter or a powered docking cradle that supplements or recharges the batteries.

The system 902 may also include a radio interface layer 972 that performs the function of transmitting and receiving radio frequency communications. The radio interface layer 972 facilitates wireless connectivity between the system 902 and the “outside world,” via a communications carrier or service provider. Transmissions to and from the radio interface layer 972 are conducted under control of the operating system 964. In other words, communications received by the radio interface layer 972 may be disseminated to the application programs 966 via the operating system 964, and vice versa.

The visual indicator 920 may be used to provide visual notifications, and/or an audio interface 974 may be used for producing audible notifications via the audio transducer 925. In the illustrated configuration, the visual indicator 920 is a light emitting diode (LED) and the audio transducer 925 is a speaker. These devices may be directly coupled to the power supply 970 so that when activated, they remain on for a duration dictated by the notification mechanism even though the processor 960/961 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 925, the audio interface 974 may also be coupled to a microphone to receive audible input, such as to facilitate a telephone conversation. In accordance with aspects of the present disclosure, the microphone may also serve as an audio sensor to facilitate control of notifications, as will be described below. The system 902 may further include a video interface 976 that enables an operation of an on-board camera to record still images, video stream, and the like.

A mobile computing device 900 implementing the system 902 may have additional features or functionality. For example, the mobile computing device 900 may also include additional data storage devices (removable and/or non-removable) such as, magnetic disks, optical disks, or tape. Such additional storage is illustrated in FIG. 9B by the non-volatile storage area 968.

Data/information generated or captured by the mobile computing device 900 and stored via the system 902 may be stored locally on the mobile computing device 900, as described above, or the data may be stored on any number of storage media that may be accessed by the device via the radio interface layer 972 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio interface layer 972 or via a distributed computing network. Similarly, such data/information may be readily transferred between computing devices for storage and use according to well-known data/information transfer and storage means, including electronic mail and collaborative data/information sharing systems.

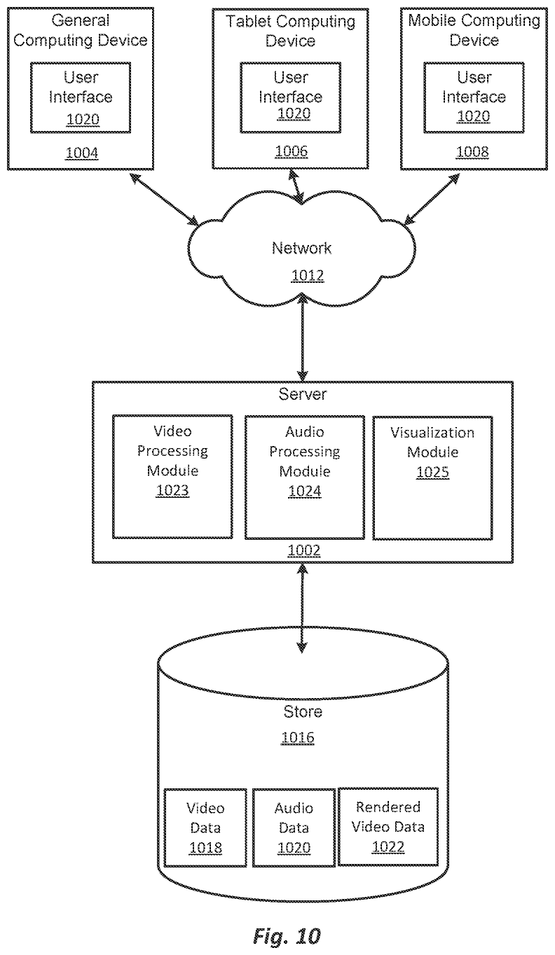

FIG. 10 illustrates one aspect of the architecture of a system for processing data received at a computing system from a remote source, such as a personal computer 1004, tablet computing device 1006, or mobile computing device 1008, as described above. Content displayed at server device 1002 may be stored in different communication channels or other storage types. For example, the computing device 1004, 1006, 1008 may represent the computing device 104 of FIG. 1, and the server device 1002 may represent the motion-audio visualization server 106 of FIG. 1.

In some aspects, one or more of a video processing module 1023, an audio processing module 1024, and a visualization module 1025, may be employed by server device 1002. The server device 1002 may provide data to and from a client computing device such as a personal computer 1004, a tablet computing device 1006 and/or a mobile computing device 1008 (e.g., a smart phone) through a network 1012. By way of example, the computer system described above may be embodied in a personal computer 1004, a tablet computing device 1006 and/or a mobile computing device 1008 (e.g., a smart phone). Any of these aspects of the computing devices may obtain content from the store 1016, in addition to receiving graphical data useable to be either pre-processed at a graphic-originating system, or post-processed at a receiving computing system. The content store may include video data 1018, audio data 1020, and rendered video data 1022.

FIG. 10 illustrates an exemplary mobile computing device 1008 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

The present disclosure relates to systems and methods for rendering motion-audio visualizations to a display according to at least the examples provided in the sections below:

(A1) In one aspect, some examples include a method for rendering motion-audio visualizations to a display. The method includes obtaining video data comprising one or more video frames, determining a position of a target object in each of the one or more video frames, obtaining audio data, determining a frequency spectrum from the audio data for a predetermined time period, determining audio visualizations for the predetermined time period based on the frequency spectrum, and generating a rendered video by applying the audio visualizations at the position of the target object in the one or more video frames for the predetermined time period.

(A2) In some examples of A1, the method includes determining positions of particle emitters based on the position of the target object in each frame of the video data, wherein the particle emitters control a source of trail particles with one or more video visualization parameters.

(A3) In some examples of A1-A2, wherein the trail particles include graphics that are rendered based on the frequency spectrum of the audio data and are applied at the positions of particle emitters in the corresponding frame of the video data.

(A4) In some examples of A1-A3, wherein the one or more video visualization parameters are associated with the video data and control a behavior of trail particles that are configured to be emitted from the particle emitters.

(A5) In some examples of A1-A4, wherein the one or more video visualization parameters comprise at least one parameter selected from a group comprising of a particle color, a spawning rate, an initial velocity vector, and a particle lifetime.

(A6) In some examples of A1-A5, wherein determining the audio visualizations for the predetermined time period based on the frequency spectrum comprises updating one or more audio visualization parameters controlling the audio visualizations to be added to the one or more video frames for a duration of the predetermined time period based on the frequency spectrum.

(A7) In some examples of A1-A6, wherein the audio visualization parameters comprises at least one parameter selected from a group comprising of a width, a height, color, and/or brightness of one or more graphics or effects to be added to the one or more video frames of the video data.

(A8) In some examples of A1-A6, the method includes generating a visualization layer with the trail particles at each position of the particle emitters, adjusting an opacity level of the visualization layer, adding the trail particles to the one or more video frames for a duration of the predetermined time period, and presenting the rendered video with motion-audio visualization to the user.

In yet another aspect, some examples include a computing system including one or more processors and memory coupled to the one or more processors, the memory storing one or more instructions which when executed by the one or more processors, causes the one or more processors perform any of the methods described herein (e.g., A1-A8 described above).

In yet another aspect, some examples include a non-transitory computer-readable storage medium storing one or more programs for execution by one or more processors of a storage device, the one or more programs including instructions for performing any of the methods described herein (e.g., A1-A8 described above).

(B1) In one aspect, some examples include a computing device for rendering motion-audio visualizations to a display. The computing device may include a processor and a memory having a plurality of instructions stored thereon that, when executed by the processor, causes the computing device to obtain video data comprising one or more video frames, determine a position of a target object in each of the one or more video frames, obtain audio data, determine a frequency spectrum from the audio data for a predetermined time period, determine audio visualizations for the predetermined time period based on the frequency spectrum, and generate a rendered video by applying the audio visualizations at the position of the target object in the one or more video frames for the predetermined time period.

(B2) In some examples of B1, the plurality of instructions, when executed, further cause the computing device to determine positions of particle emitters based on the position of the target object in each frame of the video data, wherein the particle emitters control a source of trail particles with one or more video visualization parameters

(B3) In some examples of B1-B2, wherein the trail particles include graphics that are rendered based on the frequency spectrum of the audio data and are applied at the positions of particle emitters in the corresponding frame of the video data.

(B4) In some examples of B1-B3, wherein the one or more video visualization parameters are associated with the video data and control a behavior of trail particles that are configured to be emitted from the particle emitters.

(B5) In some examples of B1-B4, wherein to determine the audio visualizations for the predetermined time period based on the frequency spectrum comprises to update one or more audio visualization parameters controlling the audio visualizations to be added to the one or more video frames for a duration of the predetermined time period based on the frequency spectrum.

(B6) In some examples of B1-B5, wherein to generate the rendered video comprises to generate a visualization layer with the trail particles at each position of the particle emitters, adjust an opacity level of the visualization layer, add the trail particles to the one or more video frames for a duration of the predetermined time period, and present the rendered video with motion-audio visualization to the use.

(C1) In one aspect, some examples include a non-transitory computer-readable medium storing instructions for rendering motion-audio visualizations to a display. The instructions when executed by one or more processors of a computing device, cause the computing device to obtain video data comprising one or more video frames, determine a position of a target object in each of the one or more video frames, obtain audio data, determine a frequency spectrum from the audio data for a predetermined time period, determine audio visualizations for the predetermined time period based on the frequency spectrum, and generate a rendered video by applying the audio visualizations at the position of the target object in the one or more video frames for the predetermined time period.

(C2) In some examples of C1, wherein the instructions when executed by the one or more processors further cause the computing device to determine positions of particle emitters based on the position of the target object in each frame of the video data, wherein the particle emitters control a source of trail particles with one or more video visualization parameters.

(C3) In some examples of C1-C2, wherein the trail particles include graphics that are rendered based on the frequency spectrum of the audio data and are applied at the positions of particle emitters in the corresponding frame of the video data.

(C4) In some examples of C1-C3, wherein the one or more video visualization parameters are associated with the video data and control a behavior of trail particles that are configured to be emitted from the particle emitters.

(C5) In some examples of C1-C4, wherein to determine the audio visualizations for the predetermined time period based on the frequency spectrum comprises to update one or more audio visualization parameters controlling the audio visualizations to be added to the one or more video frames for a duration of the predetermined time period based on the frequency spectrum.

(C6) In some examples of C1-C5, wherein to generate the rendered video comprises to generate a visualization layer with the trail particles at each position of the particle emitters, adjust an opacity level of the visualization layer, add the trail particles to the one or more video frames for a duration of the predetermined time period, and present the rendered video with motion-audio visualization to the user.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for rendering motion-audio visualizations to a display, the method comprising:
obtaining video data comprising one or more video frames;
determining a position of a target object in each of the one or more video frames;
obtaining audio data;
determining a frequency spectrum from the audio data for a predetermined time period;
determining audio visualizations for the predetermined time period based on the frequency spectrum; and
generating a rendered video by applying the audio visualizations at the position of the target object in the one or more video frames for the predetermined time period.

2. The method of claim 1, further comprising determining positions of particle emitters based on the position of the target object in each frame of the video data, wherein the particle emitters control a source of trail particles with one or more video visualization parameters.

3. The method of claim 2, wherein the trail particles include graphics that are rendered based on the frequency spectrum of the audio data and are applied at the positions of particle emitters in the corresponding frame of the video data.

4. The method of claim 2, wherein the one or more video visualization parameters are associated with the video data and control a behavior of trail particles that are configured to be emitted from the particle emitters.

5. The method of claim 2, wherein the one or more video visualization parameters comprise at least one parameter selected from a group comprising of a particle color, a spawning rate, an initial velocity vector, and a particle lifetime.

6. The method of claim 1, wherein determining the audio visualizations for the predetermined time period based on the frequency spectrum comprises updating one or more audio visualization parameters controlling the audio visualizations to be added to the one or more video frames for a duration of the predetermined time period based on the frequency spectrum.

7. The method of claim 6, wherein the audio visualization parameters comprises at least one parameter selected from a group comprising of a width, a height, color, and/or brightness of one or more graphics or effects to be added to the one or more video frames of the video data.

8. The method of claim 2, wherein generating the rendered video comprises:
generating a visualization layer with the trail particles at each position of the particle emitters;
adjusting an opacity level of the visualization layer;
adding the trail particles to the one or more video frames for a duration of the predetermined time period; and
presenting the rendered video with motion-audio visualization to the user.

9. A computing device for rendering motion-audio visualizations to a display, the computing device comprising:
a processor; and
a memory having a plurality of instructions stored thereon that, when executed by the processor, causes the computing device to:
obtain video data comprising one or more video frames;
determine a position of a target object in each of the one or more video frames;
obtain audio data;
determine a frequency spectrum from the audio data for a predetermined time period;
determine audio visualizations for the predetermined time period based on the frequency spectrum; and
generate a rendered video by applying the audio visualizations at the position of the target object in the one or more video frames for the predetermined time period.

10. The computing device of claim 9, wherein the plurality of instructions, when executed, further cause the computing device to determine positions of particle emitters based on the position of the target object in each frame of the video data, wherein the particle emitters control a source of trail particles with one or more video visualization parameters.

11. The computing device of claim 10, wherein the trail particles include graphics that are rendered based on the frequency spectrum of the audio data and are applied at the positions of particle emitters in the corresponding frame of the video data.

12. The computing device of claim 10, wherein the one or more video visualization parameters are associated with the video data and control a behavior of trail particles that are configured to be emitted from the particle emitters.

13. The computing device of claim 9, wherein to determine the audio visualizations for the predetermined time period based on the frequency spectrum comprises to update one or more audio visualization parameters controlling the audio visualizations to be added to the one or more video frames for a duration of the predetermined time period based on the frequency spectrum.

14. The computing device of claim 10, wherein to generate the rendered video comprises to:
generate a visualization layer with the trail particles at each position of the particle emitters;
adjust an opacity level of the visualization layer;
add the trail particles to the one or more video frames for a duration of the predetermined time period; and
present the rendered video with motion-audio visualization to the user.

15. A non-transitory computer-readable medium storing instructions for rendering motion-audio visualizations to a display, the instructions when executed by one or more processors of a computing device, cause the computing device to:
obtain video data comprising one or more video frames;
determine a position of a target object in each of the one or more video frames;
obtain audio data;
determine a frequency spectrum from the audio data for a predetermined time period;
determine audio visualizations for the predetermined time period based on the frequency spectrum; and
generate a rendered video by applying the audio visualizations at the position of the target object in the one or more video frames for the predetermined time period.

16. The non-transitory computer-readable medium of claim 15, wherein the instructions when executed by the one or more processors further cause the computing device to determine positions of particle emitters based on the position of the target object in each frame of the video data, wherein the particle emitters control a source of trail particles with one or more video visualization parameters.

17. The transitory computer-readable medium of claim 16, wherein the trail particles include graphics that are rendered based on the frequency spectrum of the audio data and are applied at the positions of particle emitters in the corresponding frame of the video data.

18. The transitory computer-readable medium of claim 16, wherein the one or more video visualization parameters are associated with the video data and control a behavior of trail particles that are configured to be emitted from the particle emitters.

19. The transitory computer-readable medium of claim 15, wherein to determine the audio visualizations for the predetermined time period based on the frequency spectrum comprises to update one or more audio visualization parameters controlling the audio visualizations to be added to the one or more video frames for a duration of the predetermined time period based on the frequency spectrum.

20. The transitory computer-readable medium of claim 16, wherein to generate the rendered video comprises to:
generate a visualization layer with the trail particles at each position of the particle emitters;
adjust an opacity level of the visualization layer;
add the trail particles to the one or more video frames for a duration of the predetermined time period; and
present the rendered video with motion-audio visualization to the user.
